(19) United States
(12) Patent Application Publication
(10) Pub. No.: US 2009/0108593 A1
(43) Pub. Date: Apr. 30, 2009

(54) LATCH MECHANISM

(75) Inventor: Ming-Chang Lee, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/957,504

(22) Filed: Dec. 17, 2007

(30) Foreign Application Priority Data
Oct. 31, 2007 (CN) 200710202330.9

(51) Int. Cl. E05C 1/12

(52) U.S. Cl. 292/164

(57) ABSTRACT

A latch mechanism is provided for locking a cover unit to a base unit which comprises a bottom panel and a cover panel fixed to the bottom panel. Two through holes are defined in the cover panel. The latch mechanism includes two latch members configured for being slidably installed to the bottom panel and between the bottom panel and the cover panel, two hooks installed on the cover unit, a button movably fixed to the bottom panel, and a first resilient member. Each of the latch members includes a latch portion. The hooks are configured for extending through the through holes of the cover panel to engage with the latch portions of the latch members respectively. The button includes two driving portions for driving the latch members to slide to disengage from the hooks respectively. The first resilient member is connected between the latch members for restoring the latch members.

### BACKGROUND

1. Field of the Invention

The present invention relates to latch mechanisms, and more particularly to a latch mechanism for a portable computer.

2. Description of Related Art

Typically, an electronic device, such as a portable computer, includes a cover unit and a base unit pivotally connected with the cover unit, and a latch mechanism is provided to lock the cover unit to the base unit.

As disclosed in U.S. Pat. No. 6,115,239, a latch mechanism for locking a cover unit to a base unit, includes a latch frame movably installed inside the cover unit, a plurality of latches are formed on the latch frame at predetermined intervals and one end portion of each latch protrudes from a front surface of the cover unit, and a slide knob is operatively connected to the latch frame for concurrently operating the latches. The latches are inserted into and locked by latch grooves formed at positions corresponding to the latches on an upper surface of the base unit. The latches are urged against the base unit by elastic forces applied by double springs mounted on two ends of the latch frame. However, to open the cover unit, the slide knob is slid to overcome the elastic forces of the springs to move the latch mechanism for disengaging from the base unit. The slide force depends on friction between the slide knob and fingers of an operator. It is laborious for an operator to provide enough force to move a slide knob.

What is needed, therefore, is a laborsaving latch mechanism.

### SUMMARY

In one embodiment, a latch mechanism is provided for locking a cover unit to a base unit which comprises a bottom panel and a cover panel fixed to the bottom panel. Two through holes are defined in the cover panel. The latch mechanism includes two latch members configured for being slidably installed to the bottom panel and between the bottom panel and the cover panel, two hooks installed on the cover unit, a button movably fixed to the bottom panel, and a first resilient member. Each of the latch members includes a latch portion. The hooks are configured for extending through the through holes of the cover panel to engage with the latch portions of the latch members respectively. The button includes two driving portions for driving the latch members to slide to disengage from the hooks respectively. The first resilient member is connected between the latch members for restoring the latch members.

Other advantages and novel features of the present invention will become more apparent from the following detailed description of an embodiment when taken in conjunction with the accompanying drawings, in which:

### BRIEF DESCRIPTION OF THE DRAWINGS

FIG. 1 is an exploded, isometric view of a latch mechanism with a cover unit and a base unit in accordance with a preferred embodiment of the present invention, the base unit including a bottom panel and a cover panel;

FIG. 2 shows another aspect view of the cover unit of FIG. 1;

FIG. 3 is an enlarged view of the latch mechanism of FIG. 1;

FIG. 4 is similar to FIG. 3, but an inverted view;

FIG. 5 is an assembled view of the latch mechanism together with the bottom panel of FIG. 1;

FIGS. 6 and 7 are assembled views of FIG. 1, showing two using states respectively; and

FIG. 8 shows a partially cutaway view of FIG. 6.

### DETAILED DESCRIPTION

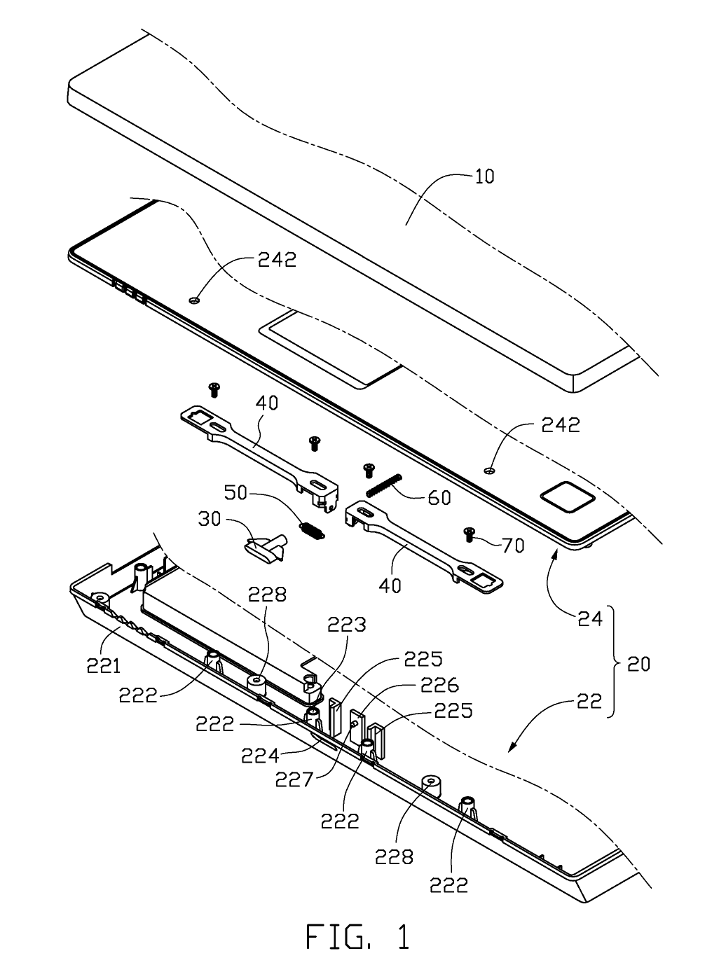

Referring to FIG. 1, a latch mechanism in accordance with an embodiment of the present invention is provided, for locking a cover unit 10 to a base unit 20 of an electronic device, such as a portable computer. The latch mechanism includes a button 30, two latch members 40, a first resilient member 50, a second resilient member 60, and a plurality of fasteners 70. In this embodiment, the first resilient members 50 and the second resilient member 60 are coil springs. The fasteners 70 are screws.

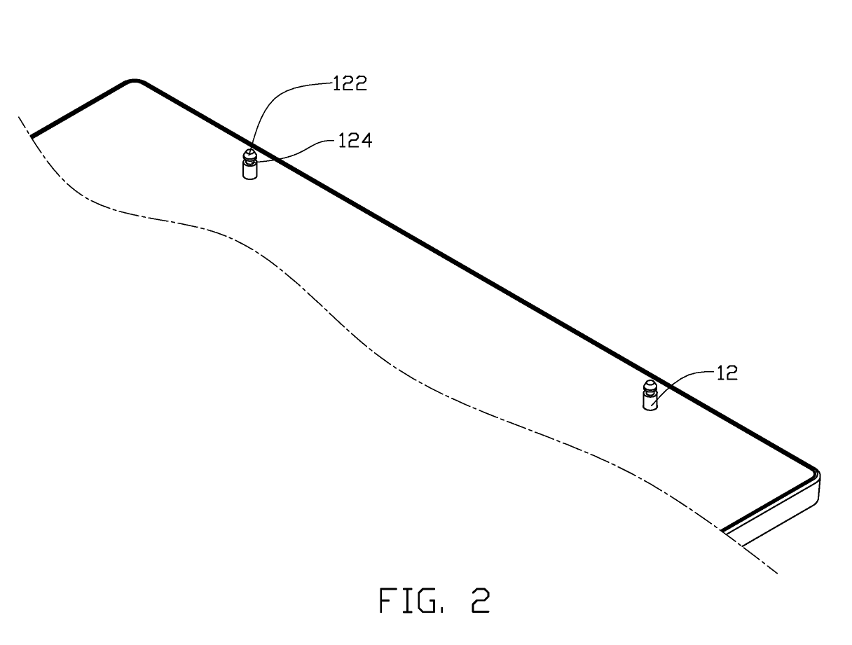

Referring also to FIG. 2, the cover unit 10 includes two hooks 12 arranged thereon at one side surface thereof. Each hook 12 includes a taper-shaped leading portion 122 formed at a free end thereof, and a locking slot 124 defined therein in the vicinity of the leading portion 122.

Referring again to FIG. 1, the base unit 20 includes a bottom panel 22 and a cover panel 24 covered on the bottom panel 22. The bottom panel 22 has a flange 221 extending from one side thereof. A receiving slot 224 is defined in a middle portion of the flange 221. The bottom panel 22 includes four columns 222, two L-shaped first blocks 225, a second block 226, and two rods 228 protruding therefrom in the vicinity of the flange 221. The four columns 222 are aligned on the bottom panel 22, parallel to the flange 221. Two of the four columns 222 are arranged at one side of the receiving slot 224, and the other two of the four columns 222 are arranged at the other side of the receiving slot 224. A mounting hole 223 is defined in each column 222. The two first blocks 225 extend from the bottom panel 22 in the vicinity of the receiving slot 224. The second block 226 is positioned between the two first blocks 225. A pole 227 extends from one side of the second block 226 towards the flange 221. The two rods 228 are arranged on two sides of the bottom panel 22 along the flange 221 respectively. The cover panel 24 defines two through holes 242 corresponding to the hooks 12 of the cover unit 10 respectively.

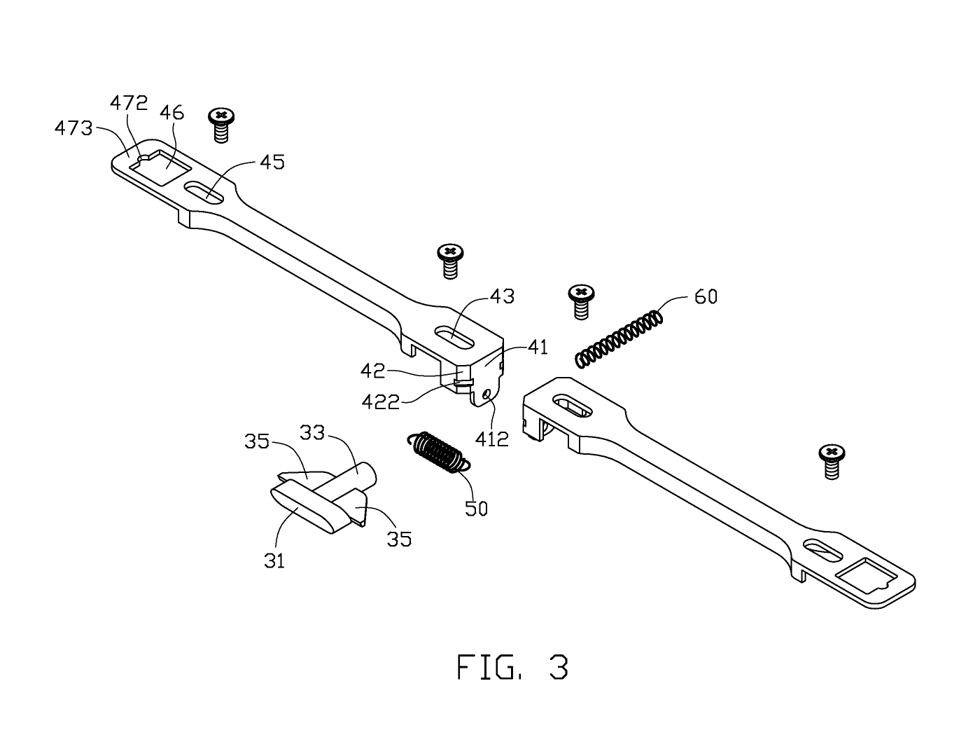

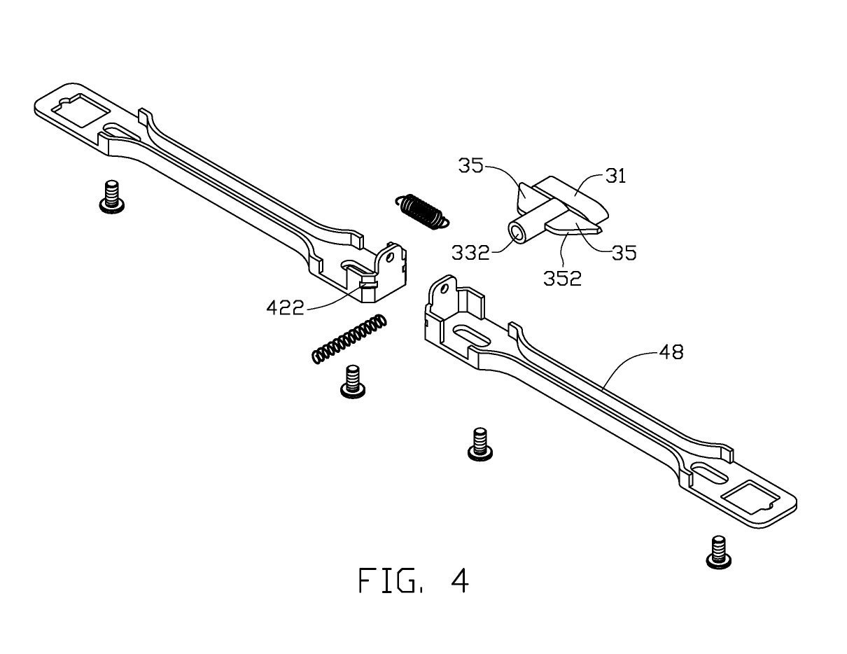

Referring also to FIGS. 3 and 4, the button 30 includes an operating portion 31, a columnar portion 33 extending from a middle of one side of the operating portion 31, and two driving portions 35 extending from opposite sides of the columnar portion 33 respectively. A hole 332 is defined in the columnar portion 33 along an axis. Each driving portion 35 is trapezium-shaped, and includes an inclined driving surface 352 opposite to the columnar portion 33.

Each latch member 40 is elongate, and includes a locking end and a driven end at opposite ends thereof respectively. The driven end includes an upright wall 41, two inclined walls 42 extending from opposite sides of the upright wall 41 respectively toward the locking end, and a first restricting slot 43 defined in the latch member 40 in the vicinity of the upright wall 41. A locking hole 412 is defined in a lower portion of the upright wall 41. A horizontal sliding slot 422 is defined in each inclined wall 42. The locking end defines a rectangular hole 46 and a second restricting slot 45 in the vicinity of the rectangular hole 46, and the locking end includes a latch portion 473 formed between a distal edge of the locking end and the rectangular hole 46. An arc-shaped cutout 472 is defined in the locking end communicating with the rectangular hole 46 adjacent to the latch portion 473. Two ribs 48 extend down from opposite sides of the latch member 40 respectively, configured for reinforcing the latch member 40.

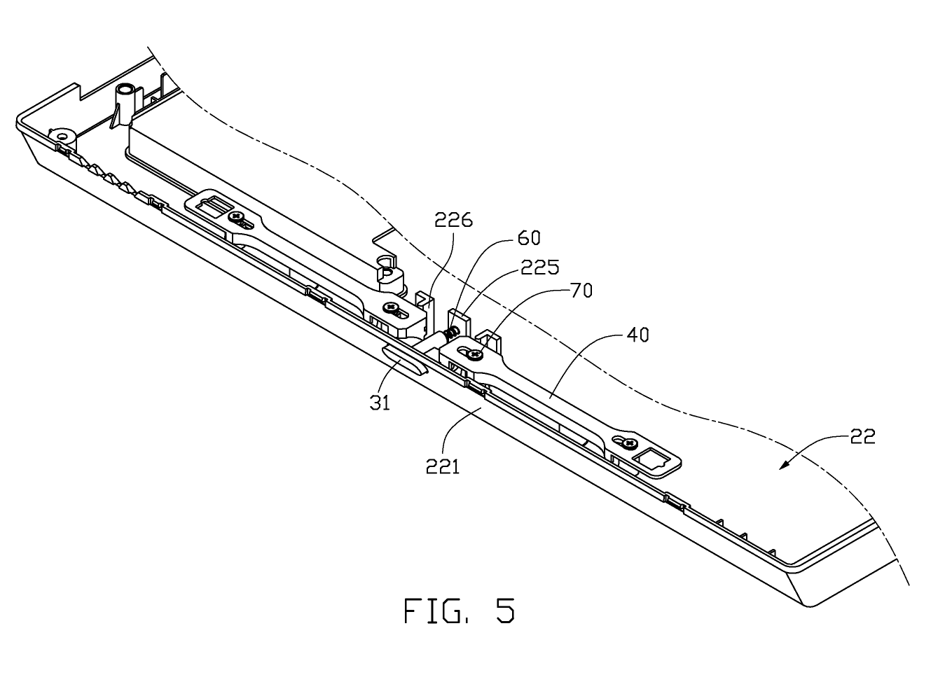

Referring also to FIG. 5, in assembly, one end of the second resilient member 60 is received in the hole 332 of the columnar portion 33 of the button 30. The operating portion 31 of the button 30 is retained in the receiving slot 224 of the flange 221 of the bottom panel 22 of the base unit 20. The other end of the resilient member 60 is fitted about the pole 227 of the second block 226 of the bottom panel 22. The latch members 40 are at opposite sides of the receiving slot 224 respectively, each being fixed to two corresponding columns 222. Four fasteners 70 extend through the first restricting slots 43 and the second restricting slots 45 of the two latch members 40 to screw in the mounting holes 223 of the columns 222 of the bottom panel 22 to movably attach the latch members 40 to the bottom panel 22. The rods 228 are configured for supporting middle portions of the latch members 40 respectively. Two ends of the first resilient member 50 are connected to the locking holes 412 of the latch members 40 respectively. Two driving surfaces 352 of the button 30 are engaged in the corresponding sliding slots 422 of the latch members 40.

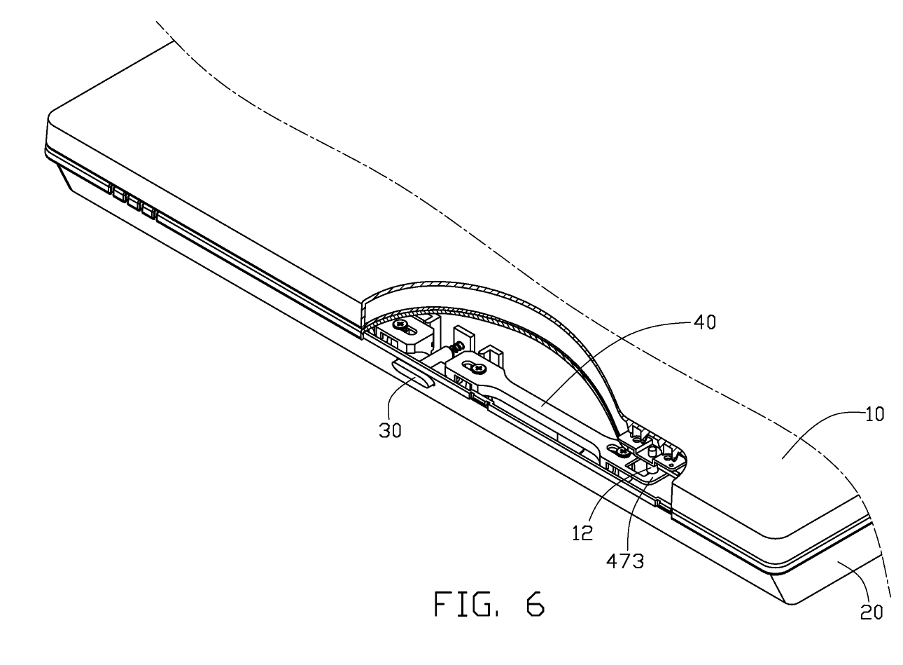

Referring also to FIG. 6, the cover panel 24 is fixed to the bottom panel 22, thereby the base unit 20 is fully assembled. The cover unit 10 is rotatably attached to the base unit 20. The cover unit 10 is rotated to cover the base unit 20 when the electronic device is not in use. The leading portions 122 of the hooks 12 of the cover unit 10 extend through the corresponding through holes 242 of the cover panel 24 of the base unit 20 to abut against the corresponding latch portion 473 of the latch members 40. The cover unit 10 is further rotated, the leading portions 122 of the hooks 12 drive the latch members 40 to slide away from the button 30 against the first resilient member 50. When the leading portions 122 of the hooks 12 entirely extend through the latch members 40 respectively, the first resilient member 50 rebounds to drive the latch members 40 to slide toward the button 30 until the latch portions 473 of the latch members 40 are engaged in the locking slots 124 of the hooks 12 respectively. Thus, the cover unit 10 is locked to the base unit 20.

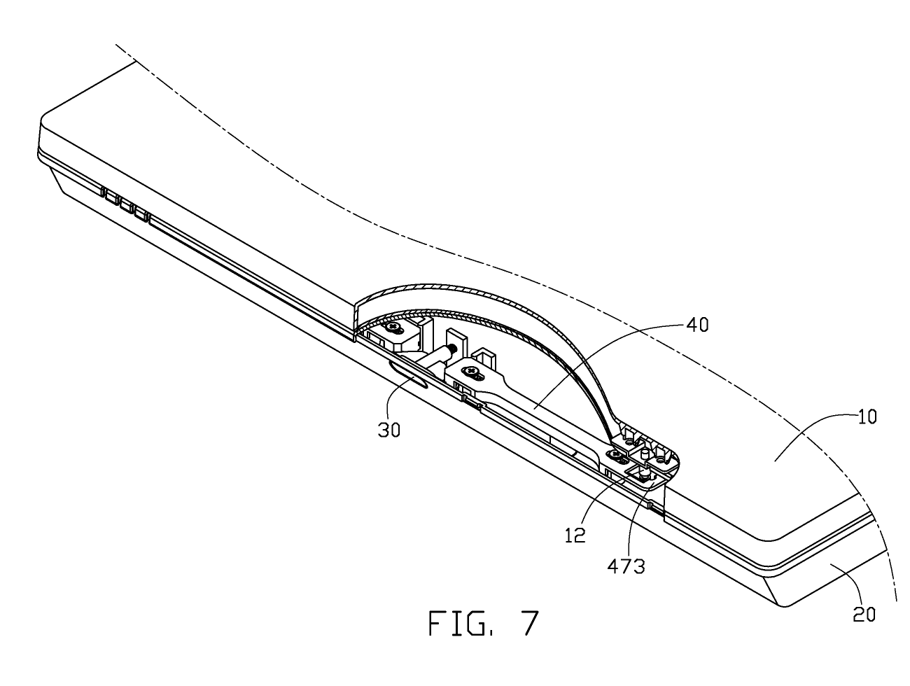

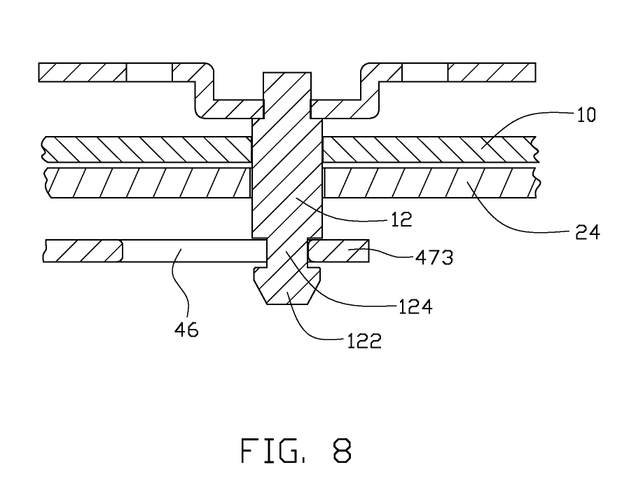

Referring also to FIG. 7, to unlock the cover unit 10 from the base unit 20, the operating portion 31 of the button 30 is pressed to move the button 30 toward the second block 226 of the bottom panel 22 compressing the second resilient member 60. The driving portions 35 of the button 30 slide in the sliding slots 422 of the latch members 40 respectively to drive the latch members 40 to move away from the button 30. When the latch portions 473 of the latch members 40 are disengaged from the locking slots 124 of the hooks 12, the cover unit 10 is released from the base unit 20.

Each first block 225 is used for blocking one side of a corresponding latch member 40 to restrict the latch members 40.

As a second embodiment of the present invention, two springs can be substituted for the first resilient member 50. Each spring is arranged between a corresponding latch member 40 and the bottom panel 22 for restoring the latch member 40.

Obviously, only using two inclined driving surfaces 352 of the button 30 without the inclined walls 42 of the latch members 40, or only using two inclined walls 42 of the latch members 40 without the inclined driving surfaces 352 can achieve a similar driving effect.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A latch mechanism for locking a cover unit to a base unit which comprises a bottom panel and a cover panel fixed to the bottom panel, two through holes are defined in the cover panel, the latch mechanism comprising:
two latch members configured for being slidably installed to the bottom panel and between the bottom panel and the cover panel, each of the latch members comprising a latch portion;
two hooks protruding from the cover unit for extending through the through holes of the cover panel to engage with the latch portions of the latch members respectively;
a button movably fixed to the bottom panel, the button comprising two driving portions for driving the latch members to slide to disengage from the hooks respectively; and
a first resilient member connected between the latch members for restoring the latch members.

2. The latch mechanism as claimed in claim 1, wherein each of the driving portions of the button comprises an inclined driving surface to engage with a corresponding latch member.

3. The latch mechanism as claimed in claim 1, wherein each of the latch members comprises an inclined wall for engaging with a corresponding driving portion of the button.

4. The latch mechanism as claimed in claim 3, wherein the inclined wall of each of the latch members defines a sliding slot therein, a corresponding driving portion of the button engages in the sliding slot.

5. The latch mechanism as claimed in claim 1, wherein a locking hole is defined in each of the latch members, the first resilient member is a spring, two ends of the spring are engaged in the locking holes of the latch members respectively.

6. The latch mechanism as claimed in claim 1, wherein the button comprises a column portion defining a hole therein, a block extends from the bottom panel corresponding to the button, a second resilient member is configured for restoring the button with one end thereof being received in the hole of the button and the other end thereof engaging with the block of the bottom panel.

7. The latch mechanism as claimed in claim 6, wherein the second resilient member is a coil spring.

8. The latch mechanism as claimed in claim 1, wherein the bottom panel has two column portions extending therefrom at one side of the button corresponding to each of the latch members, a mounting hole is defined in each of the column portions, two restricting slots are defined in each of the latch member, the latch member is slidably attached to the bottom panel via two screws extending through the restricting slots of the latch member to screw into the mounting holes of the column portions.

9. The latch mechanism as claimed in claim 1, wherein a hole is defined in each of the latch members adjacent to one end thereof, t latch portion is formed between the hole and a corresponding end of the latch member.

10. The latch mechanism as claimed in claim 1, wherein each of the hooks includes a taper-shaped leading portion formed at a free end thereof configured for engaging with the latch portion of the corresponding latch member, and a locking slot is defined in the hook in the vicinity of the leading portion configured for engaging with the latch portion of the corresponding latch member.

11. A latch mechanism for locking a cover unit to a base unit which comprises a bottom panel and a cover panel fixed to the bottom panel, a through hole is defined in the cover panel, the latch mechanism comprising:
a latch member configured for being slidably installed to the bottom panel and between the bottom panel and the cover panel, the latch member comprising a latch portion;
a hook protruding from the cover unit for extending through the through hole of the cover panel to engage with the latch portion of the latch member;
a button movably fixed to the bottom panel, the button comprising a driving portion for driving the latch member to slide to disengage from the hook; and
a first resilient member connected between the latch member and the bottom panel for restoring the latch member.
